(19) United States
(12) Patent Application Publication
(10) Pub. No.: US 2022/0114391 A1
(43) Pub. Date: Apr. 14, 2022

(54) LEARNING DATA GENERATION DEVICE, LEARNING DATA GENERATION METHOD, AND PROGRAM

(71) Applicant: NIPPON TELEGRAPH AND TELEPHONE CORPORATION, Tokyo (JP)

(72) Inventors: Yuki KURAUCHI, Tokyo (JP); Naoto ABE, Tokyo (JP); Hiroshi KONISHI, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/277,117

(22) PCT Filed: Sep. 6, 2019
(86) PCT No.: PCT/JP2019/035167

§ 371 Date: Mar. 17, 2021

(30) Foreign Application Priority Data
Sep. 19, 2018 (JP) 2018-174580

(51) Int. Cl. G06K 9/62; G06N 20/10

(52) U.S. Cl. CPC G06K 9/6257; G06N 20/10; G06K 9/6289

(57) ABSTRACT

A training data generation apparatus (10) according to the present invention includes a noise determination unit (11) that determines whether or not training data that is to be used in machine learning includes noise, and a noise addition unit (12) that generates new training data by adding noise to training data that has been determined by the noise determination unit (11) as not including noise.

### TECHNICAL FIELD

The present invention relates to a training data generation apparatus, a training data generation method, and a program.

### BACKGROUND ART

Studies have been conducted on techniques for estimating the condition (steps, slopes, etc.) of the surface of a road such as a pavement or a roadway on which a moving body such as an automobile, a pedestrian, or a wheelchair moves, by using sensors mounted on the moving body (for example, see NPL 1 and NPL 2).

### CITATION LIST

### Non Patent Literature

[NPL 1] Akihiro Miyata, Iori Araki, Tongshun Wang, Tenshi Suzuki, “A Study on Barrier Detection Using Sensor Data of Unimpaired Walkers”, IPSJ journal (2018)
[NPL 2] “Kousoku Basu ni Noseta Sumaho no Kasokudosensadêta de Romen no Outotu wo Kenti, Kensyou Siken wo Zissi (Detecting unevenness of a road surface with an acceleration sensor of a smartphone mounted on an expressway bus, verification tests conducted)” [online] [Searched on Sep. 4, 2018], the Internet <URL: https://sgforum.impress.co.jp/news/3595>

### SUMMARY OF THE INVENTION

### Technical Problem

The condition of a road surface as described above is often estimated using a model that has been built through machine learning performed using training data. However, machine learning performed using training data is problematic in that sufficient learning accuracy cannot be acquired, and in that a large amount of training data is required for machine learning, which results in an increase in costs, for example.

An object of the present invention made in view of the problems above is to provide a training data generation apparatus, a training data generation method, and a program that are capable of generating training data that realizes learning with high accuracy, while suppressing an increase in costs.

### Means for Solving the Problem

To solve the above-described problems, a training data generation apparatus according to the present invention includes a noise determination unit that determines whether or not training data that is to be used in machine learning includes noise, and a noise addition unit that generates new training data by adding noise to training data that has been determined by the noise determination unit as not including noise.

Also, to solve the above-described problems, a training data generation method according to the present invention is a training data generation method that is to be carried out by a training data generation apparatus, comprising the steps of: determining whether or not training data that is to be used in machine learning includes noise; and generating new training data by adding noise to training data that has been determined as not including noise.

Also, to solve the above-described problems, a program according to the present invention enables a computer to function as the above-described training data generation apparatus.

### Effects of the Invention

With the training data generation apparatus, the training data generation method, and the program according to the present invention, it is possible to generate training data that realizes learning with high accuracy, while suppressing an increase in costs.

### BRIEF DESCRIPTION OF DRAWINGS

FIG. 1 is a diagram showing an example of a configuration of a training data generation apparatus according to an embodiment of the present invention.

FIG. 2 is a diagram showing an example of a configuration of an estimation system that includes the training data generation apparatus shown in FIG. 1.

FIG. 3 is a flowchart illustrating a training data generation method that is to be carried out by the training data generation apparatus shown in FIG. 1.

FIG. 4 is a diagram conceptually showing operation of a noise addition unit shown in FIG. 1.

FIG. 5A is a diagram illustrating addition of noise performed by the noise addition unit shown in FIG. 1.

FIG. 5B is a diagram illustrating addition of noise performed by the noise addition unit shown in FIG. 1.

### DESCRIPTION OF EMBODIMENTS

Hereinafter, an embodiment for carrying out the present invention will be described with reference to the drawings. In the drawings, the same reference numerals indicate the same or equivalent constituent elements.

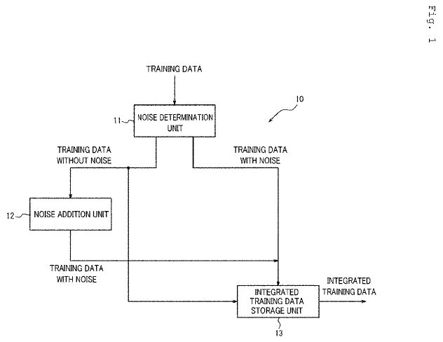

FIG. 1 is a diagram showing an example of a configuration of a training data generation apparatus 10 according to an embodiment of the present invention. The training data generation apparatus 10 according to the present embodiment generates training data that is to be used in machine learning. More specifically, the training data generation apparatus 10 according to the present embodiment generates new training data from training data that includes road surface data indicating the condition of a road surface on which a moving body such as an automobile, a pedestrian, or a wheelchair moves, detected by sensors mounted on the moving body.

The training data generation apparatus 10 shown in FIG. 1 includes a noise determination unit 11, a noise addition unit 12, and an integrated training data storage unit 13.

Training data that includes road surface data detected by sensors (such as an acceleration sensor, a gyro sensor, and a gravity sensor) mounted on the moving body is input to the noise determination unit 11 as determination-target training data. Road surface data is constituted by sensor values detected during a period in which the moving body moves on the road surface, and is a time series data. Training data that is input to the noise determination unit 11 is data formed by attaching teacher labels to road surface data acquired during a predetermined period, the teacher labels indicating the condition of the road surface (whether or not the road surface is flat, whether or not there is a step, etc.) during the predetermined period, for example. Teacher labels are manually attached, for example. It is possible that the training data to be input to the noise determination unit 11 does not have teacher labels attached thereto, and teacher labels may be attached at any point in time after the noise determination unit 11 has performed the determination described below.

The noise determination unit 11 determines whether or not the input determination-target training data (road surface data) includes noise. In general, values detected by the sensors when the moving body travels on a rough road surface fluctuate more widely than values detected by the sensors when the moving body travels on a smooth road surface. In other words, fluctuations in road surface data are small during a period in which the moving body travels on a smooth road surface, and fluctuations in road surface data are large during a period in which the moving body travels on a rough road surface. The noise determination unit 11 determines training data that includes road surface data obtained during a period in which fluctuations are large (larger than a predetermined value, for example), such as road surface data obtained during a period in which the moving body travels on a rough surface, as training data that includes noise. Similarly, the noise determination unit 11 determines training data that includes road surface data obtained during a period in which fluctuations are small (smaller than a predetermined value, for example), such as road surface data obtained during a period in which the moving body travels on a smooth surface, as training data that does not include noise. That is to say, the noise determination unit 11 determines whether or not training data includes noise based on the magnitude of fluctuations in the values of training data (the values of road surface data in the present embodiment).

Upon determining that the determination-target training data includes noise, the noise determination unit 11 adds the determination-target training data to integrated training data stored in the integrated training data storage unit 13, as training data that includes noise (hereinafter referred to as “training data with noise”). Integrated training data is data formed by integrating pieces of training data corresponding to various states to be estimated (various conditions of a road surface in the present embodiment).

Upon determining that the determination-target training data does not include noise, the noise determination unit 11 adds the determination-target training data to the integrated training data as training data that does not include noise (hereinafter referred to as “training data without noise”). Also, the noise determination unit 11 outputs the determination-target training data (training data without noise) to the noise addition unit 12.

The noise addition unit 12 adds noise to the training data determined by the noise determination unit 11 as not including noise, and the resulting data to the integrated training data stored in the integrated training data storage unit 13, as training data with noise. In other words, the noise addition unit 12 generates new training data by adding noise to the training data determined as not including noise. Details of noise addition performed by the noise addition unit 12 will be described below.

The integrated training data storage unit 13 integrates and stores the training data with noise, output from the noise determination unit 11 and the noise addition unit 12, and the training data without noise, output from the noise determination unit 11, as integrated training data. Upon a predetermined amount of training data being stored, the integrated training data storage unit 13 outputs the integrated training data stored therein.

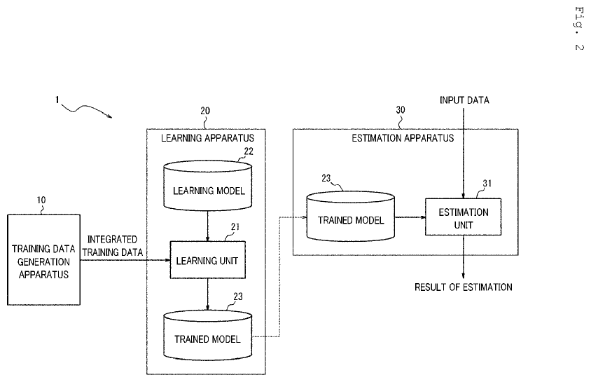

FIG. 2 is a diagram showing an example of a configuration of an estimation system 1 that includes the training data generation apparatus 10 according to the present embodiment. The estimation system 1 shown in FIG. 2 estimates the condition of the road surface on which the moving body moves, for example.

The estimation system 1 shown in FIG. 2 includes the training data generation apparatus 10, a learning apparatus 20, and an estimation apparatus 30. As described above, the training data generation apparatus 10 generates and outputs integrated training data.

The learning apparatus 20 includes a learning unit 21. The learning unit 21 performs machine learning on a learning model 22, using the training data generated by the training data generation apparatus 10, and thus builds a trained model 23. Various models, including a model using the convolutional neural network, the SVM (Support Vector Machine), and so on, may be used as the learning model 22.

The estimation apparatus 30 includes an estimation unit 31. Road surface data detected by sensors mounted on the moving body moving on a road surface is input to the estimation unit 31 as input data. The estimation unit 31 inputs the input data to the trained model 23 built by the learning apparatus 20, and outputs the output from the trained model 23 as the result of estimation of the condition of the road surface on which the moving body moves.

As described above, in the estimation system 1 shown in FIG. 2, the training data generation apparatus 10 generates integrated training data, and the learning apparatus 20 builds the trained model 23 to be used to estimate the condition of the road surface, using the integrated training data. The estimation apparatus 30 estimates the condition of the road surface, using the trained model 23 thus built.

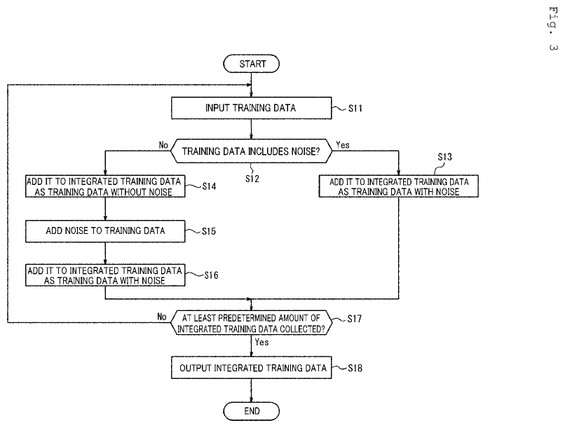

FIG. 3 is a flowchart illustrating a training data generation method that is to be carried out by the training data generation apparatus 10 according to the present embodiment.

Upon receiving input determination-target training data (step S11), the noise determination unit 11 determines whether or not the determination-target training data includes noise (step S12).

Upon determining that the determination-target training data includes noise (step S12: Yes), the noise determination unit 11 adds the determination-target training data to the integrated training data as training data with noise (step S13).

Upon determining that the determination-target training data does not include noise (step S12: No), the noise determination unit 11 adds the determination-target training data to the integrated training data as training data without noise (step S14).

The noise addition unit 12 adds noise to the training data determined by the noise determination unit 11 as not including noise (step S15), and adds the training data to which noise has been added, to the integrated training data as training data with noise (step S16).

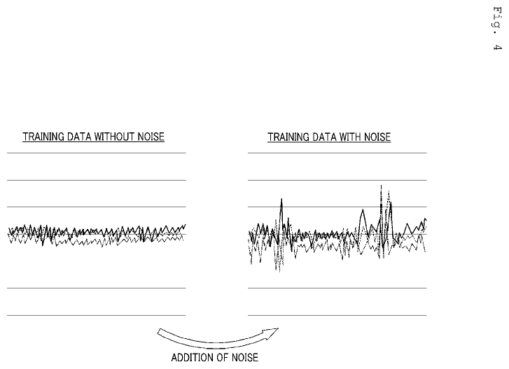

Training data that does not include noise is, for example, training data that corresponds to a case in which the road surface on which the moving body moves is smooth. As shown in FIG. 4, the noise addition unit 12 adds noise (for example, noise corresponding to a case in which the road surface on which the moving body moves has a step) to this training data. Thus, it is possible to newly generate training data that corresponds to a case in which the road surface on which the moving body moves has a step from training data that corresponds to a case in which the road surface on which the moving body moves is smooth. Therefore, it is possible to generate a sufficient amount of training data and realize learning with high accuracy, while suppressing an increase in costs.

Again, as shown in FIG. 3, after the processing in step S13 or S16, the integrated training data storage unit 13 determines whether or not at least a predetermined amount of integrated training data has been collected (step S17).

Upon determining that at least the predetermined amount of integrated training data has been collected (step S17: Yes), the integrated training data storage unit 13 outputs the integrated training data stored therein (step S18) and terminates processing.

Upon determining that at least the predetermined amount of integrated training data has not been collected (step S17: No), processing returns to step S11, and new determination-target training data is input to the noise determination unit 11.

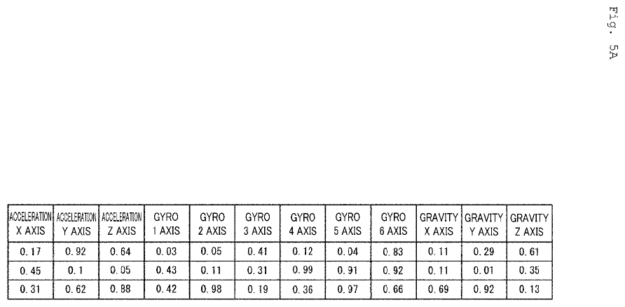

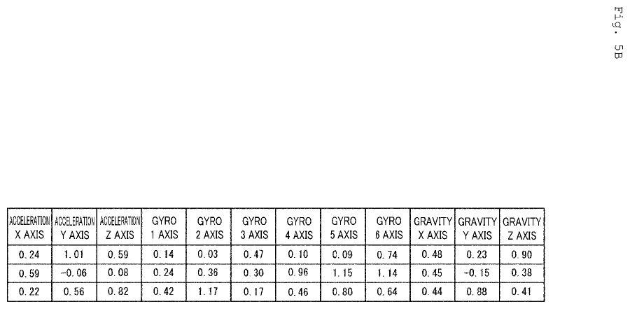

Next, addition of noise performed by the noise addition unit 12 will be described with reference to FIGS. 5A and 5B.

FIG. 5A is a diagram showing an example of training data (road surface data) to which noise has not been added. FIG. 5B is a diagram showing an example of training data (road surface data) to which noise has been added. FIGS. 5A and 5B show examples in which a plurality of types of sensors are mounted on the moving body, and road surface data is detected by each of the plurality of types of sensors. Specifically, FIGS. 5A and 5B show examples in which, as road surface data, accelerations in three axis directions (an acceleration X, an acceleration Y, and an acceleration Z) are detected by an acceleration sensor, accelerations in the roll axis, pitch axis, and yaw axis directions, and angular velocities in the roll axis, pitch axis, and yaw axis directions (a gyro 1 axis, a gyro 2 axis, a gyro 3 axis, a gyro 4 axis, a gyro 5 axis, and a gyro 6 axis) are detected by a gyro sensor, and accelerations in three axis directions caused by gravity (a gravity X, a gravity Y, and gravity Z) are detected by a gravity sensor.

The noise addition unit 12 adds noise to the training data without noise, in all directions, instead of adding noise in only the vertical direction in which detection values fluctuate due to unevenness of the road surface, for example. That is to say, the noise addition unit 12 adds noise to road surface data in the directions of the three axes (the X, Y and Z axes) that are orthogonal to each other. As a result, it is possible to build a model for estimating the condition of the road surface from training data, regardless of the orientation of the device on which the sensors that detect the road surface data are mounted.

For each of the plurality of types of sensors, the noise addition unit 12 adds, to the values detected by the sensor, noise values that are distributed in a normal distribution with a mean of 0 and a variance that is the same as the variance of the values detected by the sensor, for example. That is to say, the noise addition unit 12 adds noise values according to Formula (1) shown below, where x denotes a value detected by the sensor to which a noise value has not been added, x′ denotes the value to which a noise value has been added, and std\hat{ }2 denotes the variance of the values detected by the sensor.

x′=x+N(0,std\hat{ }2) Formula (1)

Note that N(μ,σ\hat{ }2) denotes random values that are distributed in a normal distribution with a mean of μ and a variance of σ\hat{ }2.

By adding noise values that are distributed in a normal distribution as described above in each of the three axis directions that are orthogonal to each other, it is possible to prevent the mean and the variance from significantly changing before and after the addition of the noise values. Note that noise values to be added to training data may be noise values that are not distributed in a normal distribution as described above. Also, the variance of the normal distribution may be greater than the variance of the values detected by the sensor.

In the example shown in FIG. 5A, the variance of the values detected by the acceleration sensor is 0.31, the variance of the values detected by the gyro sensor is 0.36, and the variance of the values detected by the gravity sensor is 0.30. The noise addition unit 12 adds noise values to the values detected by the sensors according to Formula (1), using the variances of the values detected by the sensors. That is to say, the noise addition unit 12 adds noise values that are distributed in a normal distribution with a mean of 0 and a variance of 0.31, to the values detected by the acceleration sensor. Also, the noise addition unit 12 adds noise values that are distributed in a normal distribution with a mean of 0 and a variance of 0.36, to the values detected by the gyro sensor. Also, the noise addition unit 12 adds noise values that are distributed in a normal distribution with a mean of 0 and a variance of 0.30, to the values detected by the gravity sensor. Training data to which noise has been added is shown in FIG. 5B.

As described above, in the present embodiment, the training data generation apparatus 10 includes a noise determination unit 11 that determines whether or not training data that is to be used in machine learning includes noise, and a noise addition unit 12 that generates new training data by adding noise to training data that has been determined by the noise determination unit 11 as not including noise.

By generating new training data by adding noise to training data that has been determined as not including noise, it is possible to generate a sufficient amount of training data and realize learning with high accuracy, while suppressing an increase in costs.

Although the present embodiment has been described using an example in which the training data generation apparatus 10 generates training data from road surface data detected by sensors mounted on a moving body, the present invention is not limited to such an example. The training data generation apparatus 10 can generate training data from various kinds of data that may include noise.

While the training data generation apparatus 10 has been described above, a computer may be used so as to function as the training data generation apparatus 10. Such a computer can be realized by storing a program that describes the content of processing performed to realize the functions of the training data generation apparatus 10, in a storage unit of the computer, and causing a CPU of the computer to read out and execute the program.

The program may be recorded on a computer-readable recording medium. By using such a recording medium, it is possible to install the program to a computer. Here, the recording medium on which the program is recorded may be a non-transitory recording medium. A non-transitory recording medium is not specifically limited, and may be a recording medium such as a CD-ROM or a DVD-ROM, for example.

Although the above embodiment has been described as a presentative example, it is obvious for a person skilled in the art that various modifications and replacements may be applied within the spirit and the scope of the present invention. Therefore, the present invention should not be construed as being limited by the above-described embodiment, and various modifications and changes may be made without departing from the scope of the claims. For example, it is possible to combine a plurality of constituent blocks described in the configuration diagram according to the embodiment into one block, or to divide one constituent block into a plurality of blocks.

### REFERENCE SIGNS LIST

1 Estimation system
10 Training data generation apparatus
11 Noise determination unit
12 Noise addition unit
13 Integrated training data storage unit
20 Learning apparatus
21 Learning unit
22 Learning model
23 Trained model
30 Estimation apparatus
31 Estimation unit

1. A training data generation apparatus comprising:
a noise determiner configured to determine whether or not training data that is to be used in machine learning includes noise; and
a noise adder configured to generate new training data by adding noise to the training data that has been determined by the noise determiner as not including noise.

2. The training data generation apparatus according to claim 1, wherein the training data includes road surface data detected by a sensor mounted on a moving body moving on a road surface, the road surface data indicating a condition of the road surface.

3. The training data generation apparatus according to claim 2, wherein the noise adder generates the new training data by adding noise to the road surface data detected by the sensor, in directions of three axes that are orthogonal to each other.

4. The training data generation apparatus according to claim 2, wherein a plurality of types of sensors are mounted on the moving body, each of the plurality of types of sensors detects the road surface data, and for each of the plurality of types of sensors, the noise adder adds, to the road surface data detected by the sensor, noise values that are distributed in a normal distribution with a mean of 0 and a variance that is the same as a variance of values detected by the sensor.

5. A training data generation method that is to be carried out by a training data generation apparatus, comprising:
determining, by a noise determiner, whether or not training data that is to be used in machine learning includes noise; and
generating, by a noise adder, new training data by adding noise to training data that has been determined as not including noise.

6. A computer-readable non-transitory recording medium storing computer-executable instructions that when executed by a processor cause a computer system to:
determine, by a noise determiner, whether or not training data that is to be used in machine learning includes noise; and
generate, by a noise adder, new training data by adding noise to training data that has been determined as not including noise.

7. The training data generation apparatus according to claim 2,
wherein the sensor includes one or more of:
an acceleration sensor,
a gyro sensor, or
a gravity sensor, and
wherein the condition of the road surface include one or more of:
a smooth surface,
a flat surface, or
a step on a road.

8. The training data generation apparatus according to claim 2, further comprising:
a model generator configured to generate, based on the training data, a trained model, wherein the trained model includes one or more of:
a convolutional neural network, or
a support vector machine model.

9. The training data generation apparatus according to claim 3, wherein a plurality of types of sensors are mounted on the moving body, each of the plurality of types of sensors detects the road surface data, and for each of the plurality of types of sensors, the noise adder adds, to the road surface data detected by the sensor, noise values that are distributed in a normal distribution with a mean of 0 and a variance that is the same as a variance of values detected by the sensor.

10. The training data generation method according to claim 5, wherein the training data includes road surface data detected by a sensor mounted on a moving body moving on a road surface, the road surface data indicating a condition of the road surface.

11. The training data generation method according to claim 10, wherein the noise adder generates the new training data by adding noise to the road surface data detected by the sensor, in directions of three axes that are orthogonal to each other.

12. The training data generation method according to claim 10, wherein a plurality of types of sensors are mounted on the moving body, each of the plurality of types of sensors detects the road surface data, and for each of the plurality of types of sensors, the noise adder adds, to the road surface data detected by the sensor, noise values that are distributed in a normal distribution with a mean of 0 and a variance that is the same as a variance of values detected by the sensor.

13. The training data generation method according to claim 10,
wherein the sensor includes one or more of:
an acceleration sensor,
a gyro sensor, or
a gravity sensor, and
wherein the condition of the road surface include one or more of:
a smooth surface,
a flat surface, or
a step on a road.

14. The training data generation method according to claim 10, the method further comprising:
generating, by a model generator, a trained model based on the training data, wherein the trained model includes one or more of:
a convolutional neural network, or
a support vector machine model.

15. The training data generation method according to claim 11, wherein a plurality of types of sensors are mounted on the moving body, each of the plurality of types of sensors detects the road surface data, and for each of the plurality of types of sensors, the noise adder adds, to the road surface data detected by the sensor, noise values that are distributed in a normal distribution with a mean of 0 and a variance that is the same as a variance of values detected by the sensor.

16. The computer-readable non-transitory recording medium of claim 6, wherein the training data includes road surface data detected by a sensor mounted on a moving body moving on a road surface, the road surface data indicating a condition of the road surface.

17. The computer-readable non-transitory recording medium of claim 16, wherein the noise adder generates the new training data by adding noise to the road surface data detected by the sensor, in directions of three axes that are orthogonal to each other.

18. The computer-readable non-transitory recording medium of claim 16, wherein a plurality of types of sensors are mounted on the moving body, each of the plurality of types of sensors detects the road surface data, and for each of the plurality of types of sensors, the noise adder adds, to the road surface data detected by the sensor, noise values that are distributed in a normal distribution with a mean of 0 and a variance that is the same as a variance of values detected by the sensor.

19. The computer-readable non-transitory recording medium of claim 16,
wherein the sensor includes one or more of:
an acceleration sensor,
a gyro sensor, or
a gravity sensor, and
wherein the condition of the road surface include one or more of:
a smooth surface,
a flat surface, or
a step on a road.

20. The computer-readable non-transitory recording medium of claim 16, the computer-executable instructions when executed further causing the system to:
generate, by a model generator, a trained model based on the training data, wherein the trained model includes one or more of:
a convolutional neural network, or
a support vector machine model.
